(19) United States
(12) Patent Application Publication
(10) Pub. No.: US 2026/0159973 A1
(43) Pub. Date: Jun. 11, 2026

(54) DATA MINING METHOD, ELECTROLYSIS DEVICE, ELECTROLYSIS METHOD, OXYGEN EVOLUTION CATALYST, AND HYDROGEN EVOLUTION CATALYST

(71) Applicants: TOHOKU UNIVERSITY, Sendai-shi (JP); The University of Sydney, New South Wales (AU)

(72) Inventors: Hao LI, Sendai-shi (JP); Xue JIA, Sendai-shi (JP); Li WEI, New South Wales (AU)

(21) Appl. No.: 19/409,003

(22) Filed: Dec. 4, 2025

(30) Foreign Application Priority Data
Dec. 6, 2024 (JP) 2024-213860

(51) Int. Cl. C25B 11/077; C01G 41/00; C25B 1/04; C25B 9/19

(52) U.S. Cl. CPC C25B 11/077; C01G 41/006; C25B 1/04; C25B 9/19; C01P 2002/72; C01P 2006/40

(57) ABSTRACT

An electrolysis device includes a first electrode, a first catalyst layer provided on the first electrode, a second electrode, a second catalyst layer provided on the second electrode, a membrane disposed between the first electrode and the second electrode, a solution that surrounds the first electrode, the first catalyst layer, the second electrode, the second catalyst layer, and the membrane, and contains water and an electrolyte, a container containing the solution, and a power source connected between the first electrode and the second electrode through a wiring, wherein the first catalyst layer and the second catalyst layer contain RbSbWO₆.

### BACKGROUND OF THE INVENTION

### Cross-Reference to Related Application

The present application is based upon and claims the right of priority to JP Patent Application No. 2024-213860, filed on December 6, 2024, the disclosure of which is hereby incorporated by reference herein in its entirety for all purposes.

### Field of the Invention

The present invention relates to a data mining method, an electrolysis device, an electrolysis method, an oxygen evolution catalyst, and a hydrogen evolution catalyst.

### Description of Related Art

Devices that electrolyze compounds such as oxygen, chlorine, and hydrogen in a solution containing an electrolyte are known. When a potential difference is generated between two electrodes in contact with the solution, the compounds in the solution are electrolyzed, and molecules such as oxygen and chlorine can be generated from the side of the positive electrode and hydrogen can be generated from the side of the negative electrode. In consideration of chemical stability, platinum compounds and ruthenium dioxide are generally used as catalysts for the positive electrode or negative electrode (Patent Document 1, etc.), but there is a challenge in reducing the operating cost of electrolysis devices according to an electrolytic reaction using them. Inexpensive catalysts having catalytic performance equivalent to that of platinum compounds are required.

As a general method for searching for unknown metal oxides, data mining using computational material databases is known. This data mining can be used to search for metal oxides having predetermined catalytic performance. However, the results predicted by data mining may not match the experimental results. If data mining does not consider the surface state of metal oxides, the metal oxides may be incorrectly identified through such data mining. There is a need for a data mining method in which metal oxides having predetermined catalytic performance can be searched for with high accuracy.

### Patent Documents

Patent Document 1 WO2018/194008

### SUMMARY OF THE INVENTION

The present invention has been made in view of the above circumstances, and an object of the present invention is to provide an electrolysis device, an electrolysis method, and a catalyst layer used in electrolysis (oxygen evolution catalyst and hydrogen evolution catalyst), which use an inexpensive metal oxide having excellent catalytic performance, and a data mining method that enables searching for a metal oxide among a plurality of materials.

In order to achieve the above object, the present invention provides the following aspects.

An oxygen evolution catalyst according to one aspect of the present invention includes RbSbWO₆.

A hydrogen evolution catalyst according to one aspect of the present invention includes RbSbWO₆.

An electrolysis device according to one aspect of the present invention includes a first electrode, a first catalyst layer provided on the first electrode, a second electrode, a second catalyst layer provided on the second electrode, a membrane disposed between the first electrode and the second electrode, a solution that surrounds the first electrode, the first catalyst layer, the second electrode, the second catalyst layer, and the membrane, and contains water and an electrolyte, a container containing the solution, and a power source connected between the first electrode and the second electrode through a wiring, wherein the first catalyst layer and the second catalyst layer contain RbSbWO₆.

An electrolysis method according to one aspect of the present invention includes a process of preparing a solution containing water and an electrolyte; and a process of generating a potential difference between two electrodes in contact with the solution, wherein a catalyst layer containing RbSbWO₆ is provided on the surfaces of the two electrodes.

In the electrolysis method according to (4), preferably, the pH of the electrolyte around the catalyst layer and the potential of the first electrode which has a high potential between the two electrodes are adjusted so that the values are included in a region between a first line segment and a second line segment in a Pourbaix diagram, the first line segment being a line segment connecting a point at which the pH is 0 and the potential is 1.23 V and a point at which the pH is 14 and the potential is 0.404 V, and the second line segment being a line segment connecting a point at which the pH is 0 and the potential is 2 V and a point at which the pH is 14 and the potential is 1.174 V.

In the electrolysis method according to (4), preferably, the pH of the electrolyte around the catalyst layer and the potential of the second electrode which has a low potential between the two electrodes are adjusted so that the values are included in a region between a first line segment and a second line segment in a Pourbaix diagram, the first line segment being a line segment connecting a point at which the pH is 0 and the potential is 0 V and a point at which the pH is 14 and the potential is -0.826 V, and the second line segment being a line segment connecting a point at which the pH is 0 and the potential is -0.8 V and a point at which the pH is 14 and the potential is -1.626 V.

In the electrolysis method according to (4), the pH around the catalyst layer may be 1.3 or more and 12.6 or less.

A data mining method according to one aspect of the present invention is a data mining method of searching for a metal oxide as a catalyst in an oxygen evolution reaction and a hydrogen evolution reaction, including a first process of selecting a predetermined metal oxide from metal oxides recorded in a database, a second process of selecting a metal oxide that satisfies the condition that Eₕᵤₗₗ is 0 from the metal oxides selected in the first process, a third process of selecting a metal oxide that satisfies the condition that E_{Form} is minimized from the metal oxides selected in the second process, a fourth process of creating a Pourbaix diagram for each metal oxide selected in the third process, with a stable region being a pH and potential region in which the Gibbs free energy is 0.5 eV·atom⁻¹ or less, and a fifth process of selecting, as an electrode catalyst, a metal oxide that is stable in a predetermined reaction, with reference to the Pourbaix diagram created in the fourth process.

In the data mining method according to (8), combinations of the metal oxides selected in the third process and the Pourbaix diagrams created in the fourth process may be recorded in a predetermined recording device, and the metal oxide to be used as the electrode catalyst may be selected by searching records in the recording device.

The data mining method according to (8) or (9) may further include a process of selecting one containing a predetermined number of metal elements from the metal oxides selected in the third process.

In the data mining method according to any one of (8) to (10), the metal oxide may be selected by examining a surface state in consideration of the differences in surface coverages and pores in surface structures.

In the data mining method according to (11), the surface structure may be considered by applying microkinetic modeling.

According to the present invention, it is possible to provide an electrolysis device, an electrolysis method, and a catalyst layer used in electrolysis (oxygen evolution catalyst and hydrogen evolution catalyst), which use an inexpensive metal oxide having excellent catalytic performance, and a data mining method that enables searching for a metal oxide among a plurality of materials. In the data mining of the present invention, in consideration of the surface state of metal oxides, it is possible to prevent erroneous identification of metal oxides.

### BRIEF DESCRIPTION OF THE DRAWINGS

FIG. 1 shows a configuration diagram of an electrolysis device used in an electrolysis method according to a first embodiment of the present invention.

FIG. 2 shows a configuration diagram of an electrolysis device used in an electrolysis method according to a second embodiment of the present invention.

FIG. 3 shows a process flow of a data mining method according to one embodiment of the present invention.

FIG. 4 is a graph showing the numbers of metal oxides selected in processes of examples.

FIG. 5 is a graph showing metal oxides after a third process classified according to the number of metal elements contained.

FIG. 6A is a diagram showing classified reactions in which metal elements exhibit thermodynamic stability in solutions with a pH of 0.

FIG. 6B is a diagram showing classified reactions in which metal elements exhibit thermodynamic stability in solutions with a pH of 7.

FIG. 6C is a diagram showing classified reactions in which metal elements exhibit thermodynamic stability in solutions with a pH 14.

FIG. 7 is a graph showing the results of X-ray diffraction measurement performed on RbSbWO₆ synthesized in examples.

FIG. 8 is a graph showing the results of measurements of the change in active state over time for RbSbWO₆ in an acidic solution and an alkaline solution.

FIG. 9 is a graph showing the measurement results of current-voltage characteristics obtained when water electrolysis is performed using RbSbWO₆ in an acidic solution.

FIG. 10 is a graph showing the measurement results of current-voltage characteristics obtained when water electrolysis is performed using RbSbWO₆ in an alkaline solution.

FIG. 11 is a Pourbaix diagram showing the surface state of the specify catalyst layer.

FIG. 12 is a Pourbaix diagram showing the surface state of the catalyst layer during a hydrogen evolution reaction.

### DETAILED DESCRIPTION OF THE INVENTION

Hereinafter, an electrolysis method and a data mining method according to embodiments to which the present invention is applied will be described in detail with reference to the drawings. Here, in the drawings used in the following description, in order to facilitate understanding of features, feature parts are enlarged for convenience of illustration in some cases, and dimensional ratios of components are not necessarily the same as actual ones. In addition, materials, sizes, and the like provided as exemplary examples in the following description are examples, and the present invention is not limited thereto, and they can be appropriately changed and implemented within a range not changing the scope and spirit of the invention.

### FIRST EMBODIMENT

### Electrolysis device

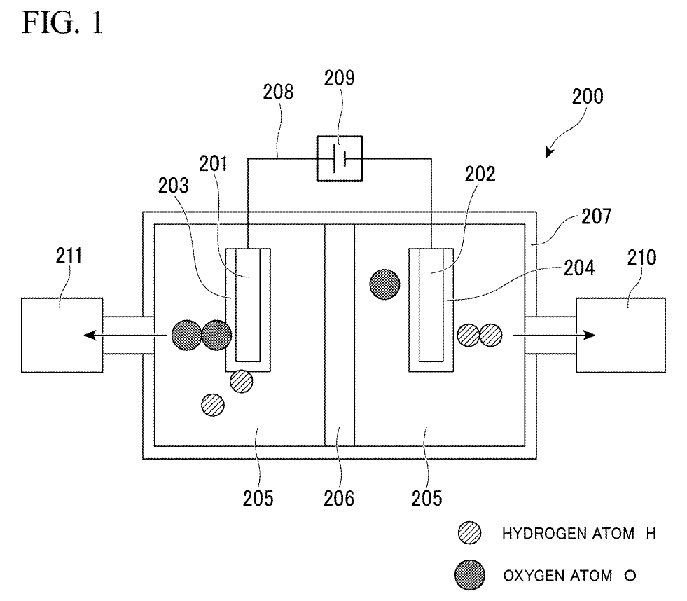

FIG. 1 is a diagram schematically showing the configuration of an electrolysis device 200 used in an electrolysis method according to a first embodiment of the present invention. The electrolysis device 200 mainly include two electrodes (a first electrode 201 and a second electrode 202), catalyst layers (a first catalyst layer 203 and a second catalyst layer 204) provided on the electrodes, a solution 205 surrounding the two electrodes and the catalyst layer, a membrane (separator) 206 disposed between the two electrodes, a container 207 containing them, and a power source 209 connected between the two electrodes through a wiring 208.

The first electrode 201 and the second electrode 202 are made of a chemically stable and conductive material (platinum, ruthenium dioxide, etc.). The solution 205 contains an oxidizing agent (a substance to be electrolyzed) and an electrolyte (electrolytic solution) in a predetermined ratio. The electrolyte is a chemically stable substance through which substances (in the present embodiment, oxygen molecules O₂ and hydrogen molecules H₂) generated by electrolysis easily propagate. The solution 205 is preferably provided not only between the first electrode 201 and the second electrode 202, but also around the entire periphery of the first electrode 201, and the entire periphery of the second electrode 202. The membrane 206 has a mesh structure with a size through which the generated oxygen molecules O₂ and hydrogen molecules H₂ cannot pass.

The first catalyst layer (catalyst layer, oxygen evolution catalyst) 203 formed on the surface of the first electrode 201 and the second catalyst layer (catalyst layer, hydrogen evolution catalyst) 204 formed on the surface of the second electrode 202 contain RbSbWO₆ (molecules) as an essential material. The first catalyst layer 203 and the second catalyst layer 204 may contain only RbSbWO₆ or may contain RbSbWO₆ as a main component, preferably at 10% or more, for example, 90%. The thickness of the first catalyst layer 203 is not particularly limited.

The formation of the first catalyst layer 203 containing RbSbWO₆ is not particularly limited, and can be performed in the same procedure as in the first catalyst layer 203 of the first embodiment.

### Electrolysis method

An electrolysis method of the present embodiment is a method of generating oxygen and hydrogen, and mainly includes the following first process and second process.

### First process

A solution containing a substance to be electrolyzed and an electrolyte in a predetermined ratio is prepared. The substance to be electrolyzed is not particularly limited, and for example, a compound of oxygen and hydrogen such as water (H₂O) can be used. Here, the case where water is used will be provided as an exemplary example.

### Second process

The prepared solution is placed in a predetermined container, and two electrodes (the first electrode 201 and the second electrode 202) are brought into contact with the solution. A potential difference is generated between the first electrode 201 and the second electrode 202. This potential difference can be generated by applying a voltage between the first electrode 201 serving as a positive electrode and the second electrode 202 serving as a negative electrode. In this case, relatively, the first electrode 201 has a high potential, and the second electrode 202 has a low potential. The first catalyst layer 203 and the second catalyst layer 204 each containing RbSbWO₆ are provided on the surfaces of the first electrode 201 and the second electrode 202, respectively.

In consideration of chemical stability, it is preferable to adjust the pH of the solution 205 around the first catalyst layer 203 and the potential of the first electrode 201 so that the values are included in a region between a first line segment and a second line segment in the Pourbaix diagram. In this case, preferably, the first line segment is a line segment connecting a point at which the pH is 0 and the potential is 1.23 V and a point at which the pH is 14 and the potential is 0.404 V, and the second line segment is a line segment connecting a point at which the pH is 0 and the potential is 2 V and a point at which the pH is 14 and the potential is 1.174 V.

In addition, from the same viewpoint, it is preferable to adjust the pH of the solution 205 around the second catalyst layer 204 and the potential of the second electrode 202 so that the values are included in a region between a first line segment and a second line segment in the Pourbaix diagram. In this case, preferably, the first line segment is a line segment connecting a point at which the pH is 0 and the potential is 0 V and a point at which the pH is 14 and the potential is -0.826 V, and the second line segment is a line segment connecting a point at which the pH is 0 and the potential is -0.8 V and a point at which the pH is 14 and the potential is -1.626 V.

Due to a potential difference between the first electrode 201 and the second electrode 202, the oxidizing agent (here, an oxygen compound) in the solution 205 is electrolyzed into oxygen atoms and other atoms. The oxygen atoms are attracted to the first electrode 201 which has a high potential, and the hydrogen atoms are attracted to the second electrode 202 which has a low potential.

In the first catalyst layer 203, oxygen atoms attracted to the first electrode 201 undergo an oxygen evolution reaction (OER) in which they combine in pairs to generate oxygen molecules. Hydrogen atoms attracted to the second electrode 202 undergo a hydrogen evolution reaction (HER) in which they combine in pairs to generate hydrogen molecules. The generated molecules can be collected, for example, by collection devices 210 and 211 connected to the container.

As described above, according to the electrolysis method of the present embodiment, the first catalyst layer 203 containing RbSbWO₆ is provided on the first electrode 201 that generates oxygen molecules O₂. The second catalyst layer 204 containing RbSbWO₆ is provided on the second electrode 202 that generates hydrogen molecules H₂. RbSbWO₆ can be synthesized more inexpensively than platinum compounds, and has a catalytic performance equivalent to that of platinum compounds. In both the oxygen evolution reaction occurring at the first electrode 201 and the hydrogen evolution reaction occurring at the second electrode 202, a large current can be extracted with RbSbWO₆ therebetween. In addition, since an RbSbWO₆ is composed of chemically stable elements, it is possible to maintain catalytic performance for a long time, and as a result, a large current can be extracted.

### SECOND EMBODIMENT

### Electrolysis device

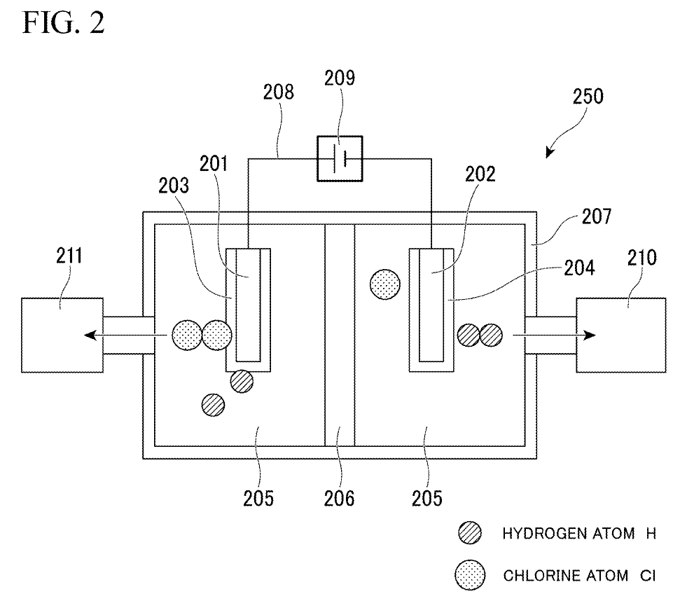

FIG. 2 is a diagram schematically showing the configuration of an electrolysis device 250 used in an electrolysis method according to a second embodiment of the present invention. The present embodiment differs from the first embodiment only in that a chlorine compound and a hydrogen compound are used as a substance to be electrolyzed. Components of the electrolysis device 250 are the same as components of the electrolysis device 200 according to the first embodiment.

In the present embodiment, the solution 205 contains a chlorine compound, water and an electrolyte. The electrolyte is a chemically stable substance through which substances (in the present embodiment, chlorine molecules Cl₂ and hydrogen molecules H₂) generated by electrolysis easily propagate. The membrane 206 has a mesh structure with a size through which the generated chlorine molecules Cl₂ and hydrogen molecules H₂ cannot pass.

### Electrolysis method

An electrolysis method of the present embodiment is a method of generating chlorine, and mainly includes the following first process and second process.

### First process

A solution containing an oxidizing agent (a substance to be electrolyzed) and an electrolyte in a predetermined ratio is prepared. The oxidizing agent is not particularly limited, and for example, a chlorine compound such as sodium chloride (NaCl) can be used.

### Second process

The prepared solution is placed in a predetermined container, and two electrodes (the first electrode 201 and the second electrode 202) are brought into contact with the solution to generate a potential difference between the first electrode 201 and the second electrode 202. Relatively, the first electrode 201 has a high potential, and the second electrode 202 has a low potential. The first catalyst layer 203 containing RbSbWO₆ is provided on the surface of the first electrode 201 on the high potential side.

In addition, in consideration of chemical stability, it is preferable to adjust the pH of the solution 205 around the first catalyst layer 203 and the potential of the first electrode 201 so that the values are included in a region between a first line segment and a second line segment in the Pourbaix diagram. In this case, preferably, the first line segment is a line segment connecting a point at which the pH is 0 and the potential is 1.36 V and a point at which the pH is 14 and the potential is 0.534 V, and the second line segment is a line segment connecting a point at which the pH is 0 and the potential is 2.16 V and a point at which the pH is 14 and the potential is 1.334 V.

In addition, from the same viewpoint, it is preferable to adjust the pH of the solution 205 around the second catalyst layer 204 and the potential of the second electrode 202 so that the values are included in a region between a first line segment and a second line segment in the Pourbaix diagram. In this case, preferably, the first line segment is a line segment connecting a point at which the pH is 0 and the potential is 0 V and a point at which the pH is 14 and the potential is -0.826 V, and the second line segment is a line segment connecting a point at which the pH is 0 and the potential is -0.8 V and a point at which the pH is 14 and the potential is -1.626 V.

Due to a potential difference between the first electrode 201 and the second electrode 202, the chlorine compound in the solution 205 is electrolyzed into chlorine atoms and other atoms, and water in the solution 205 is electrolyzed into hydrogen atoms and oxygen atoms. Chlorine atoms are attracted to the first electrode 201 which has a high potential. Hydrogen atoms are attracted to the second electrode 202 which has a low potential.

In the first catalyst layer 203, chlorine atoms attracted to the first electrode 201 undergo a chlorine evolution reaction (CER) in which they combine in pairs to generate chlorine molecules. Hydrogen atoms attracted to the second electrode 202 also undergo a hydrogen evolution reaction (HER) in which they combine in pairs to generate hydrogen molecules. The generated molecules can be collected, for example, by the collection devices 210 and 211 connected to the container.

As described above, according to the electrolysis method of the present embodiment, the first electrode 201 that generates chlorine molecules Cl₂ has the first catalyst layer 203 containing RbSbWO₆, and the second electrode 202 that generates hydrogen molecules H₂ has the second catalyst layer 204 containing RbSbWO₆ . RbSbWO₆ can be synthesized more inexpensively than platinum compounds, and has a catalytic performance equivalent to that of platinum compounds. In the chlorine evolution reaction occurring at the first electrode 201, a large current can be extracted with RbSbWO₆ therebetween. In addition, since an RbSbWO₆ is composed of chemically stable elements, it is possible to maintain catalytic performance for a long time, and as a result, a large current can be extracted.

### Data mining method

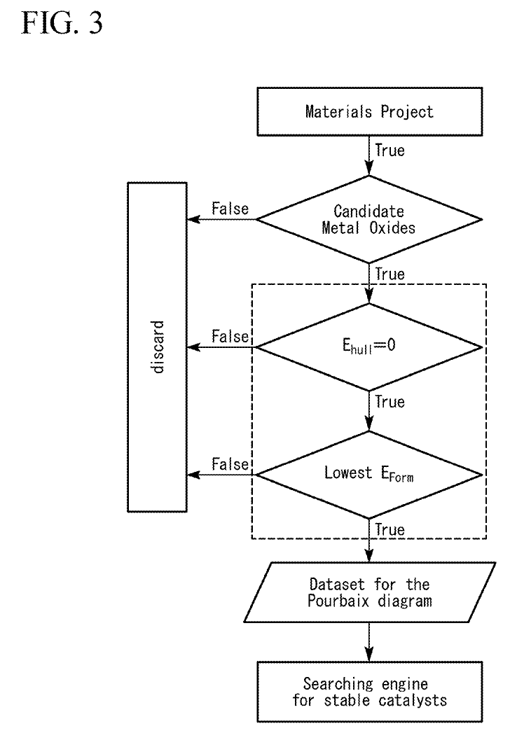

FIG. 3 is a process flow of a data mining method according to one embodiment of the present invention. The data mining method of the present embodiment is a method of searching for a metal oxide electrode catalyst, and mainly includes the following processes.

### First process

From metal oxides recorded in the database, predetermined metal oxides are selected and other metal oxides are excluded. Examples of metal oxides to be selected include metal oxides that can be obtained at low costs, and metal oxides that do not contain a radioactive element, a halogen element, an element that is a gas at room temperature and atmospheric pressure, an organic element or the like.

### Second process

From the metal oxides selected in the first process, metal oxides that satisfy the condition that the Energy above hull (Ehull) that is an index of relative thermodynamic stability is 0 are selected, and other metal oxides are excluded. Eₕᵤₗₗ can be determined by first principle calculation, and metal oxides with a lower Eₕᵤₗₗ are more stable and most easy to produce.

### Third process

From the metal oxides selected in the second process, metal oxides that satisfy the condition that the formation energy E_{Form} is minimized are selected, and other metal oxides are excluded. After the third process, a process of selecting one containing a predetermined number of metal elements from the metal oxides selected in the third process may be additionally provided.

### Fourth process

A Pourbaix diagram is created for each metal oxide selected in the third process, with a stable region being a pH and potential region in which the Gibbs free energy is 0.5 eV·atom⁻¹ or less.

### Fifth process

With reference to the Pourbaix diagram created in the fourth process, a metal oxide that is stable in the oxygen evolution reaction and the hydrogen evolution reaction is selected as an electrode catalyst. For example, when an acidic solution is used as an electrolytic solution, a metal oxide that is stable in a potential range corresponding to a pH range of the acidic solution in the Pourbaix diagram is selected. In addition, for example, when an alkaline solution is used as an electrolytic solution, a metal oxide that is stable in a potential range corresponding to a pH range of the alkaline solution in the Pourbaix diagram is selected.

Combinations of the metal oxides selected in the third process and the Pourbaix diagrams created in the fourth process may be recorded in a predetermined recording device, and a new metal oxide to be used as the electrode catalyst may be selected by searching the records in the recording device. The recording device may be an online search engine that allows searching in a network environment connected to the Internet.

In the above data mining method, metal oxides may be selected by examining the surface state in consideration of differences in surface coverages and pores in surface structures. In this case, the surface structure may be considered by applying microkinetic modeling.

According to the above data mining method, it is possible to search for not only generally known single-component metal oxides (compounds of one metal element and oxygen) but also multi-component metal oxides (compounds of a plurality of metal elements and oxygen). Examples of single-component metal oxides to be searched for include Sb₂O and W₂O₃. In addition, examples of multi-component metal oxides to be searched for include Hg(SbO₃)₂, Cd(SbO₃)₂, Zn(SbO₃)₂, Mn(SbO₃)₂, Ni(SbO₃)₂, Co(SbO₃)₂, Fe(SbO₃)₂, Sc₂(MoO₄)₃, Fe₂(MoO₄)₃, GaSbO₄, BiSbO₄, CsSbWO₆, RbSbWO₆, Ge₃Sb₂O₉, MgCr₂O₄, Sb₂WO₆, TiSnO₃,and Li₄CrFe₃O₈.

As the single-component metal oxide, a metal oxide (Sb₂O, etc.) containing Sb is excellent as an electrode catalyst involved in an oxygen evolution reaction and an oxygen reduction reaction. In addition, W has the second highest stability after Sb, and as the multi-component metal oxide, a metal oxide containing Sb and W (Sb₂WO₆, etc.) is excellent as an electrode catalyst that accelerates an oxygen evolution reaction and an oxygen reduction reaction.

As described above, according to the data mining method of the present embodiment, it is possible to easily and accurately search for metal oxides that function as an electrode catalyst in a predetermined reaction. In the fourth process, for each metal oxide, a pH and potential region in which the Gibbs free energy is 0.5 eV·atom⁻¹ or less is identified. Thereby, it is possible to identify metal oxides that are thermodynamically stable and suitable for a predetermined reaction with high accuracy.

### Examples

Hereinafter, the effects of the present invention will be more clearly understood with reference to examples. Here, the present invention is not limited to the following examples, and can be appropriately modified and implemented without departing from the spirit and scope of the invention.

### Data mining

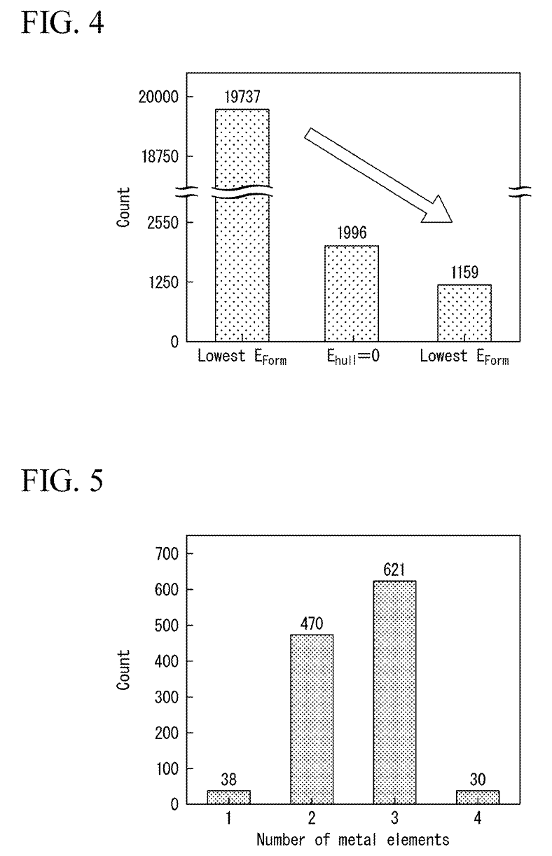

The data mining method of the above embodiment was performed on metal oxides recorded in the database. FIG. 4 is a graph showing the numbers of metal oxides selected after the first process, after the second process, and after the third process. By the third process, the number of predetermined metal oxide candidates to be selected was narrowed to 1159.

FIG. 5 is a graph showing the 1,159 selected metal oxides classified according to the number of metal elements that constitute them. Among the 1159 selected metal oxides, metal oxides containing two metal elements and metal oxides containing three metal elements are particularly abundant.

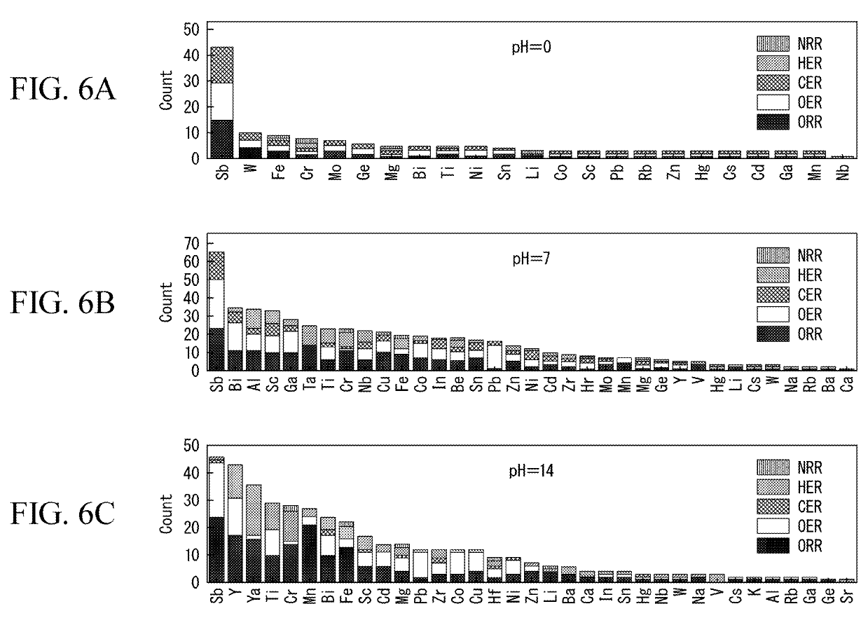

FIGS. 6A, 6B, and 6C are graphs comparing the thermodynamic stability of metal elements in reactions (nitrogen reduction reaction (NRR), hydrogen evolution reaction (HER), chlorine evolution reaction (CER), oxygen evolution reaction (OER), and oxygen reduction reaction (ORR)) in aqueous solutions with a pH of 0, 7, and 14. Regardless of the state of the aqueous solution, Sb has the best stability in the OER and ORR.

Based on these results, it was found that, as a single-component metal oxide, a metal oxide (Sb₂O) containing Sb was excellent as an electrode catalyst involved in an oxygen evolution reaction and an oxygen evolution reaction. In addition, it was found that, since W had the second highest stability after Sb, as a multi-component metal oxide, a metal oxide containing Sb and W was excellent as the electrode catalyst.

### Evaluation of RbSbWO6

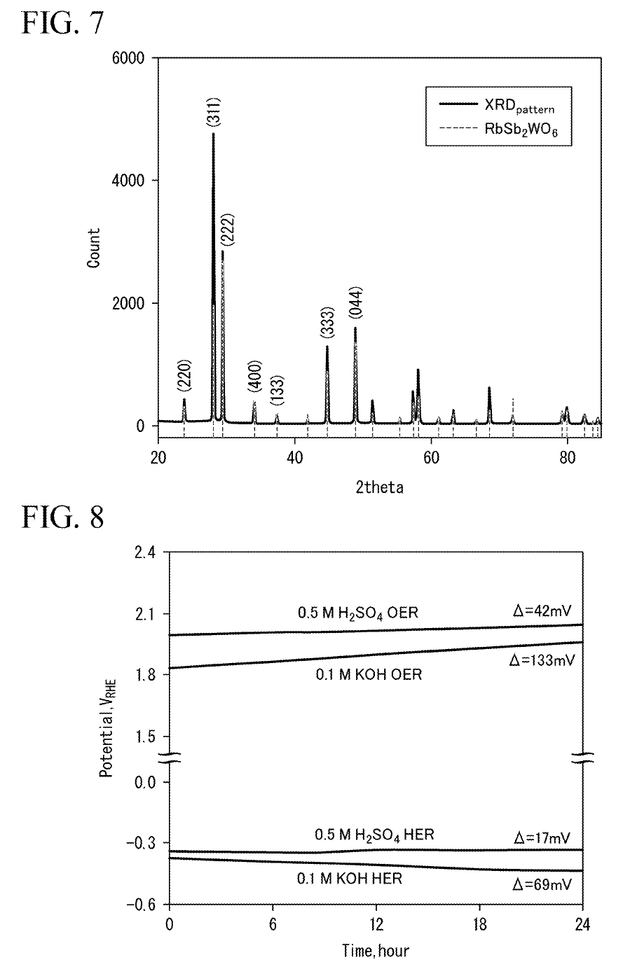

Among the found metal oxides, RbSbWO₆ was synthesized, and RbSbWO₆ was subjected to X-ray diffraction (XRD) measurement. FIG. 7 is a graph showing the measurement results. The diffraction peak positions of the synthesized RbSbWO₆ were almost the same as the diffraction peak positions of standard RbSbWO₆. Based on the results, it was found that the synthesized RbSbWO₆ had the same crystal structure as standard RbSbWO₆.

### Evaluation of active state

Water electrolysis was performed in a 0.5 M H₂SO₄ solution and a 0.1 M KOH solution, and the change in active state over time was measured in an oxygen evolution reaction and a hydrogen evolution reaction using RbSbWO₆ as a catalyst. FIG. 8 is a graph showing the results. It was found that the active state was maintained for a long time both in the oxygen evolution reaction and the hydrogen evolution reaction, and a higher active state was exhibited in the reaction in an acidic H₂SO₄ solution than the reaction in an alkaline KOH solution.

### Evaluation of stability

In a 0.5 M H₂SO₄ solution and a 1 M KOH solution, OER and HER were performed using RbSbWO₆ as a catalyst. The catalyst was mixed with a conductive additive (carbon black, Vulcan XC-72R) in a mass ratio of 4:1, and supported on a glassy carbon electrode (0.2 cm²) at 0.5 mg·cm⁻² (metal oxide basis). For the HER, pre-cycling was performed at 50 mVs⁻¹ between 0.1 and -0.6 V_{RHE}. For the OER, pre-cycling was performed at 50 mVs⁻¹ between 1 and 1.6 V_{RHE}_{,} and LSV curves were then obtained at 5 mVs⁻¹ and a rotational speed of 1,600 rpm.

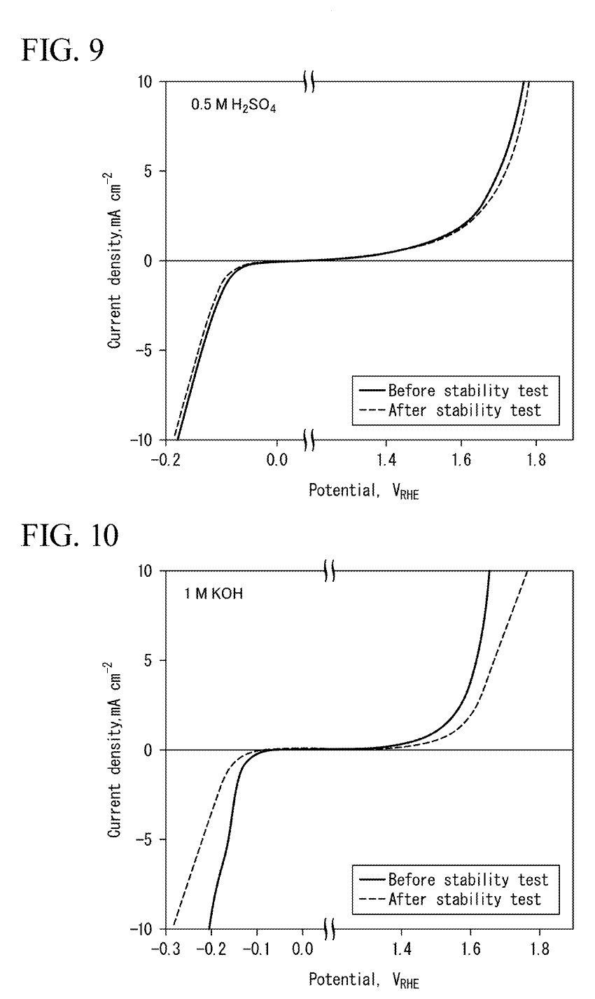

FIGS. 9 and 10 are graphs showing the measurement results of HER performance and OER performance obtained in a 0.5 M H₂SO₄ electrolyte and a 0.1 M KOH electrolyte. It was found that RbSbWO₆ exhibited higher stability in terms of catalytic performance for promoting current characteristics when used in an acidic H₂SO₄ solution than when used in an alkaline KOH solution.

### Analysis of surface state

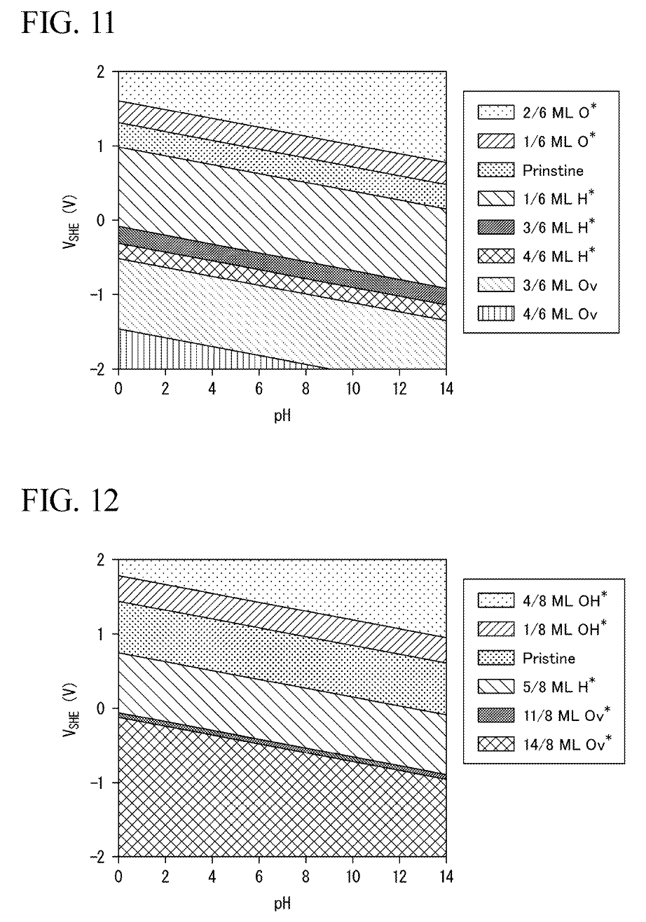

For electrolysis using a catalyst layer containing RbSbWO₆, Pourbaix diagrams were created, and surface structures A and B of the catalyst layer were analyzed. FIGS. 11 and 12 are Pourbaix diagrams showing the surface state of the catalyst layer during the oxygen evolution reaction and during the hydrogen evolution reaction. The surface structure A contained four Rb sites, two W sites, and four O sites. The surface structure B contained four Sb sites, two W sites, and 14 O sites.

From FIG. 11, the following can be understood. At the OER potential of 1.23 to 2.0 V_{SHE}, the surface structure A retained the original state or was covered with 1/6 ML of O^{*}or 2/6 ML of O^{*}. On the other hand, at the HER potential of -0.8 to 0 V_{SHE}, the surface structure A was covered with 1/6 ML of H^{*}, 3/6 ML of H^{*}, 4/6 ML of H^{*}, or 3/6 ML of Ov.

In FIG. 12, at the OER potential of 1.23 to 2.0 V_{SHE}, the surface structure B was covered with 1/8 ML of OH^{*} or 4/8 ML of OH^{*}. On the other hand, at the HER potential of -0.8 to 0 V_{SHE}, the surface structure B was covered with 5/8 ML of H^{*}, 11/8 ML of Ov, or 14/8 ML of Ov.

### EXPLANATION OF REFERENCES

200, 250 Electrolysis device

201 First electrode

202 Second electrode

203 First catalyst layer

204 Second catalyst layer

205 Solution

206·Membrane

207 Container

208 Wiring

209 Power source

210, 211 Collection device

What is claimed is:

1. An oxygen evolution catalyst comprising RbSbWO₆.

2. A hydrogen evolution catalyst comprising RbSbWO₆.

3. An electrolysis device, comprising:
a first electrode;
a first catalyst layer provided on the first electrode;
a second electrode;
a second catalyst layer provided on the second electrode;
a membrane disposed between the first electrode and the second electrode;
a solution that surrounds the first electrode, the first catalyst layer, the second electrode, the second catalyst layer, and the membrane, and contains water and an electrolyte;
a container containing the solution; and
a power source connected between the first electrode and the second electrode through a wiring,
wherein the first catalyst layer and the second catalyst layer contain RbSbWO₆.

4. An electrolysis method, comprising:
a process of preparing a solution containing water and an electrolyte; and
a process of generating a potential difference between two electrodes in contact with the solution,
wherein a catalyst layer containing RbSbWO₆ is provided on the surfaces of the two electrodes.

5. The electrolysis method according to claim 4,
wherein the pH of the electrolyte around the catalyst layer and the potential of the first electrode which has a high potential between the two electrodes are adjusted so that the values are included in a region between a first line segment and a second line segment in a Pourbaix diagram,
the first line segment is a line segment connecting a point at which the pH is 0 and the potential is 1.23 V and a point at which the pH is 14 and the potential is 0.404 V, and
the second line segment is a line segment connecting a point at which the pH is 0 and the potential is 2 V and a point at which the pH is 14 and the potential is 1.174 V.

6. The electrolysis method according to claim 4,
wherein the pH of the electrolyte around the catalyst layer and the potential of the second electrode which has a low potential between the two electrodes are adjusted so that the values are included in a region between a first line segment and a second line segment in a Pourbaix diagram,
the first line segment is a line segment connecting a point at which the pH is 0 and the potential is 0 V and a point at which the pH is 14 and the potential is -0.826 V, and
the second line segment is a line segment connecting a point at which the pH is 0 and the potential is -0.8 V and a point at which the pH is 14 and the potential is -1.626 V.

7. The electrolysis method according to claim 4, wherein the pH around the catalyst layer is 1.3 or more and 12.6 or less.

8. A data mining method of searching for a metal oxide as a catalyst in an oxygen evolution reaction and a hydrogen evolution reaction, comprising:
a first process of selecting a predetermined metal oxide from metal oxides recorded in a database;
a second process of selecting a metal oxide that satisfies the condition that Eₕᵤₗₗ is 0 from the metal oxides selected in the first process;
a third process of selecting a metal oxide that satisfies the condition that E_{Form} is minimized from the metal oxides selected in the second process;
a fourth process of creating a Pourbaix diagram for each metal oxide selected in the third process, with a stable region being a pH and potential region in which the Gibbs free energy is 0.5 eV·atom⁻¹ or less; and
a fifth process of selecting, as an electrode catalyst, a metal oxide that is stable in a predetermined reaction, with reference to the Pourbaix diagram created in the fourth process.

9. The data mining method according to claim 8, wherein combinations of the metal oxides selected in the third process and the Pourbaix diagrams created in the fourth process are recorded in a predetermined recording device, and the metal oxide to be used as the electrode catalyst is selected by searching records in the recording device.

10. The data mining method according to claim 8, further comprising a process of selecting one containing a predetermined number of metal elements from the metal oxides selected in the third process.

11. The data mining method according to claim 8, wherein the metal oxide is selected by examining a surface state in consideration of the differences in surface coverages and pores in surface structures.

12. The data mining method according to claim 11, wherein the surface structure is considered by applying microkinetic modeling.
